(19) United States
(12) Patent Application Publication
(10) Pub. No.: US 2025/0102388 A1
(43) Pub. Date: Mar. 27, 2025

(54) Sensing Device Having Split Port Geometry

(71) Applicant: Sensata Technologies, Inc., Attleboro, MA (US)

(72) Inventors: Chen Xu, Changzhou, Jiangsu (CN); Wenlong Xu, Changzhou, Jiangsu (CN); Martijn H.W. Stopel, Hengelo (ov) (NL); Werner J.P. Kleissen, Hengelo (NL); Chun Chen, Changzhou, Jiangsu (CN); Hao Jing, Changzhou, Jiangsu (CN)

(21) Appl. No.: 18/834,063

(22) PCT Filed: Jan. 29, 2022
(86) PCT No.: PCT/CN2022/075028

§ 371 Date: Jul. 29, 2024

(51) Int. Cl. G01L 19/00

(52) U.S. Cl. CPC G01L 19/003; G01L 19/0046

(57) ABSTRACT

Sensing devices as well as methods of making and using the same. The sensing devices may include a pedestal (360,66,760) having a sensing element assembly (302) associated therewith and a port assembly (370,406,770) configured to mate with the pedestal (360,66,760). The port assembly (370,406,770) may include an axial passage (522) having a top portion (363) including an undercut feature (521,621,721) positioned to engage with a welded portion.

### BACKGROUND

Sensor devices may be used to measure environmental conditions. For example, a pressure sensor device may be used in an industrial application to monitor and electrically convey pressure conditions to a remote location over a wired link or wireless connection. One type of pressure sensor apparatus includes multiple components. For example, a pressure sensor apparatus can include a metal base component and a shell to house pressure sensor electronics and a sense element. The pressure sensor electronics in the pressure sensor apparatus can be configured to receive a signal from the sense element (e.g., a capacitive sense element, resistive sense element, etc.). The sense element may detect a pressure of a fluid received through a conduit of the metal base component. The signal transmitted from the sense element to the pressure sensor electronics varies depending on the sensed pressure of the fluid. In addition to the metal base component, a pressure sensor apparatus can further include a connector component electrically coupled to the pressure sensor electronics.

Certain hermetic analog pressure sensors may offer various measuring ranges and are ideal for use in general industrial applications in the middle and high pressure ranges. Some sensors offer extreme shock and vibration capabilities, a wide operating temperature range, and high proof and burst pressures. These types of sensors may be used in a variety of applications, including, but not limited to, hydraulics and pneumatics, air conditioning and refrigeration, mobile hydraulics and off-highway vehicles, plant engineering and automation, pumps and compressors, etc.

### SUMMARY OF THE DISCLOSURE

As will be discussed in greater detail below, embodiments of the present disclosure are directed towards sensing devices as well as methods of making and using the same. Embodiments of sensing devices may include a pedestal having a sensing element assembly associated therewith and a port assembly configured to mate with the pedestal. The port assembly may include an axial passage having a top portion including an undercut feature positioned to engage with a welded portion

Some or all of the following features may be included. The undercut feature may include a rounded portion. The sensing element assembly may include a pressure sensor. The port assembly may be welded to the sensing element assembly. The sensing element assembly may include a strain gauge. The pedestal may include a generally round shape or an elliptical shape. The pedestal may include a glass portion located on the top of the pedestal. The pedestal may include a base portion having an inner diameter and a top portion and a bottom portion each having a larger diameter than the base portion. An internal guide may be included that may be configured to allow for positioning of the sensing element assembly or the port assembly. At least a portion of the sensing element assembly may extend through a top portion of the port assembly. Numerous other features are also within the scope of the present disclosure.

In another implementation, a method for manufacturing a sensing device is provided. The method may include providing a port assembly having an axial passage disposed therein, wherein the axial passage includes a top portion having an undercut feature. The method may include welding the undercut features with at least a portion of the port assembly and attaching a pedestal having a sensing element assembly associated therewith to the port assembly.

Some or all of the following features may be included, the undercut feature includes a rounded portion, the sensing element assembly includes a pressure sensor. The method may further include generating a fillet portion resulting from the welding. The sensing element assembly may include a strain gauge. The pedestal may include a generally round shape or an elliptical shape. The pedestal may include a glass portion located on the top of the pedestal. The pedestal may further include a base portion having an inner diameter and a top portion and a bottom portion each having a larger diameter than the base portion. The method may also include positioning the sensing element assembly or the port assembly using an internal guide. The method may further include extending at least a portion of the sensing element assembly through a top portion of the pedestal. Numerous other operations are also within the scope of the present disclosure.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

This summary is provided to introduce a selection of concepts that are further described below in the detailed description. This summary is not intended to identify essential features of the claimed subject matter, nor is it intended to be used as an aid in limiting the scope of the claimed subject matter.

### BRIEF DESCRIPTION OF THE DRAWINGS

Embodiments of the present disclosure are described with reference to the following figures.

FIG. 1 is a diagram illustrating an isometric view of an assembled sensor apparatus according to embodiments of the present disclosure;

FIG. 2 is a diagram illustrating an isometric view of the sensor apparatus of FIG. 1 prior to assembly;

FIG. 3 illustrates a sensor apparatus consistent with embodiments of the present disclosure;

FIG. 4 illustrates a sensor apparatus with a separated top pedestal portion consistent with embodiments of the present disclosure;

FIG. 5 illustrates a cross sectional view of a sensor apparatus consistent with embodiments of the present disclosure;

FIG. 6 illustrates an enlarged view of the undercut feature of FIG. 5;

FIG. 7 illustrates a cross sectional view of a sensor apparatus consistent with embodiments of the present disclosure;

FIG. 8 illustrates an enlarged view of the undercut feature of FIG. 7; and

FIG. 9 illustrates a flowchart showing operations consistent with embodiments of the present disclosure.

Like reference symbols in the various drawings may indicate like elements.

### DETAILED DESCRIPTION

The discussion below is directed to certain implementations. It is to be understood that the discussion below is only for the purpose of enabling a person with ordinary skill in the art to make and use any subject matter defined now or later by the patent “claims” found in any issued patent herein.

It is specifically intended that the claimed combinations of features not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered a same object or step.

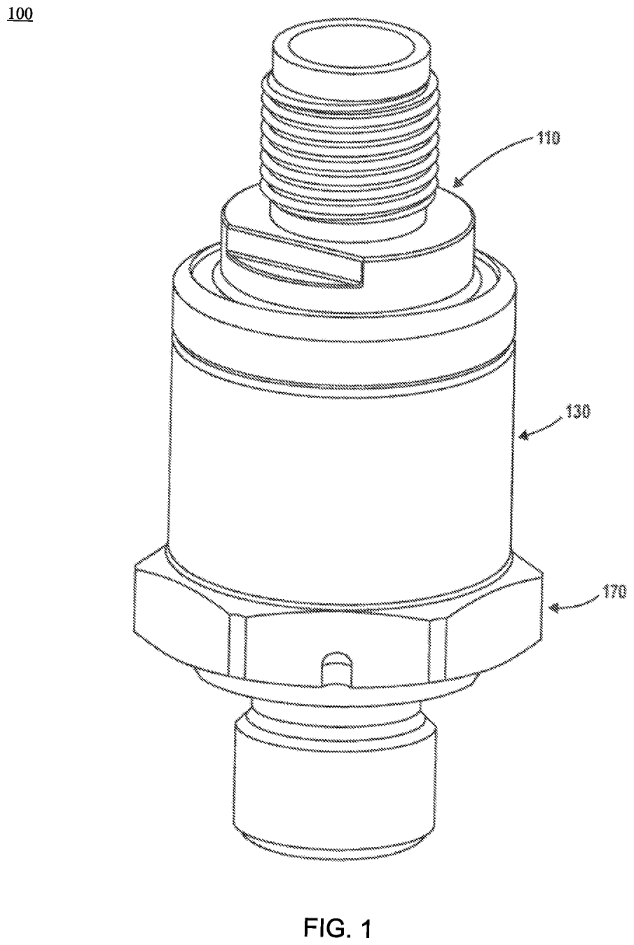

FIG. 1 is a diagram illustrating an isometric view of an assembled sensor apparatus (100) having a crimped housing in accordance with the present disclosure. As one non-limiting example, the apparatus (100) may be a pressure sensor well-suited for industrial or automotive applications, or in heating, ventilation, and air conditioning (HVAC) systems. For example, the apparatus (100) may be used to detect coolant pressure, oil or fuel pressure, hydraulic pressure, and other fluid and gas pressures. As other non-limiting examples, the apparatus (100) may be a pressure switch, a temperature sensor, a combined temperature and pressure sensor, and other sensors that will occur to those of skill in the art. Additional information regarding sensors such as those depicted in FIG. 1 may be found in U.S. Pat. Pub. 2021/0148778, available from the Assignee of the present disclosure, which is hereby incorporated by reference in its entirety.

In some embodiments, The apparatus (100) of FIG. 1 includes a connector (110) coupled to a thin-walled tubular housing (hereafter, “housing”) (130). In a particular embodiment, the housing (130) may be a metal housing with a wall thickness between 0.2 mm and 2.0 mm. In FIG. 1, the housing (130) is seated on a port (170). For example, the connector (110) may be an electrical connector for connecting external components to electrical components contained within the housing (130), as will be explained in the following description. The port (170) may be a connector (e.g. a mechanical pressure connector) capable of connecting to a fluid channel and exposing sensor components within the housing (130) to a liquid or gas, as will be explained in the following description.

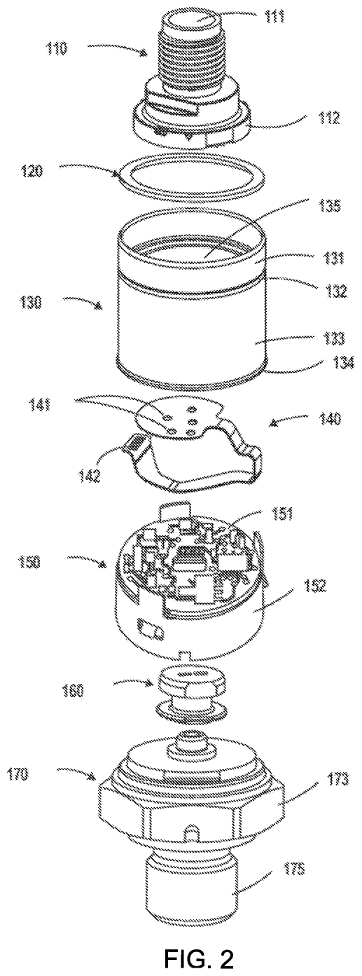

FIG. 2 is a diagram illustrating an isometric view of the sensor apparatus (100) of FIG. 1 prior to assembly. The connector (110) may be, for example, an electrical connector in accordance with well-known electrical connector packaging and interfaces. Examples of such electrical connectors include but are not limited to M12 type connectors, Metri-Pack type connectors, any DIN standard type connectors, Deutsch standard type connectors, or fly lead type connectors, and other such connectors as will be recognized by those of skill in the art. One or more electrical leads transmit electrical signals from electrical components within the housing (130) to external components. The connector (110) includes a connector flange (112) that sits inside the housing (130). The connector flange (112) provides a support around which the housing (130) may be crimped, as will be described in further detail herein.

In some embodiments, housing (130) may be a stamped metal housing with a crimping portion (131) and a base portion (133) separated by a step feature (132) useful to seating the connector (110) in the housing (130) and to crimping the crimping portion (131) of the housing (130) to the connector (110). The housing (130) may be further coupled to the port (170) by, for example, welding or crimping a bottom rim (134) of the base portion (133) of the housing (130) to the port (170). A cavity (135) of the housing (130) encloses a flexible circuit board (140), a circuit module (150), and a sense element apparatus (160). In some embodiments, a seal (120) may be applied to the connector (110) and the housing (130) to hermetically seal the cavity (135).

In some embodiments, flexible circuit board (140) may be configured in accordance with a pin configuration of the leads of the connector (110). That is, electrical contacts (141) in the flexible circuit board (140) are configured to receive electrical leads of the connector (110). The flexible circuit board (140) includes a cable (142) for connection to the circuit module (150). The flexible circuit board (140) receives electrical signals from the circuit module (150) via the cable (142) and relays those signals to the electrical leads of the connector (110). Thus, a flexible circuit board (140) corresponding to the type of the connector (110) may be used to adapt the connector (110) to the circuit module (150) without configuring the circuit module (150) for a specific type of connector. In some embodiments, the flexible circuit board (140) may be replaced with flexible conducting wires (not shown) that connect to the electrical leads at one end and the circuit module (150) at the other end. The flexible conducting wires (not shown) may be connected to the electrical leads and the circuit module (150) via connectors, soldering, or any other electrical connection method that will occur to those of skill in the art.

In some embodiments, circuit module (150) comprises circuitry (151) configured to process, transmit, and/or stores signals from the sense element (160). For example, the circuitry may be an application specific integrated circuit (ASIC) configured to convert signals from the sense element (160) into data understandable by an external component. The circuit module (150) may include a base (152) that supports the circuitry (151) within the housing (130). The base (152) may be seated on the port (170).

In some embodiments, sense element apparatus (160) may be configured to sense the pressure of fluid within an axial passage (522) of the port (170), and may have a lower surface exposed to fluid within the axial passage (522) of the port (170) or may be off center with respect to the axial passage (522). For example, the sense element apparatus (160) may include capacitive sense elements, resistive sense elements designed to measure to flexure of a diaphragm, or the like. The junction of the bottom of the sense element apparatus (160) and the port (170) may be sealed to prevent fluid within the axial passage (522) from flowing into the cavity (135) of the housing (130). The sense element apparatus (160) is coupled to the circuit module (150), which processes, transmits, and/or stores signals from the sense element (160).

In some embodiments, the port (170) may be, for example, a pressure connector according to well-known pressure connector interfaces and thread sizes. Examples of such pressure connectors include G1/4A DIN3852-E, 7-16/20UNF, NPT1/4, or PT1/4 pressure ports, and other such connectors as will be recognized by those of skill in the art. As another example, the port (170) may be a temperature sensor port. The port (170) includes a port connector (175) that may be inserted into a fluid channel for detecting, for example, the pressure or temperature of the fluid in that channel. The port connector (175) of the port (170) may introduce fluid from the fluid channel to the sense element apparatus (160) through an axial passage (522) in the port (170). The port (170) can be made of any suitable material such as brass, copper, alloy, moldable plastic, etc. In one embodiment, the port (170) is milled out of metal such as brass, aluminum, copper, stainless steel, etc. The port (170) may include a hexagonal flange (173) or other suitable pattern to enable application of torque.

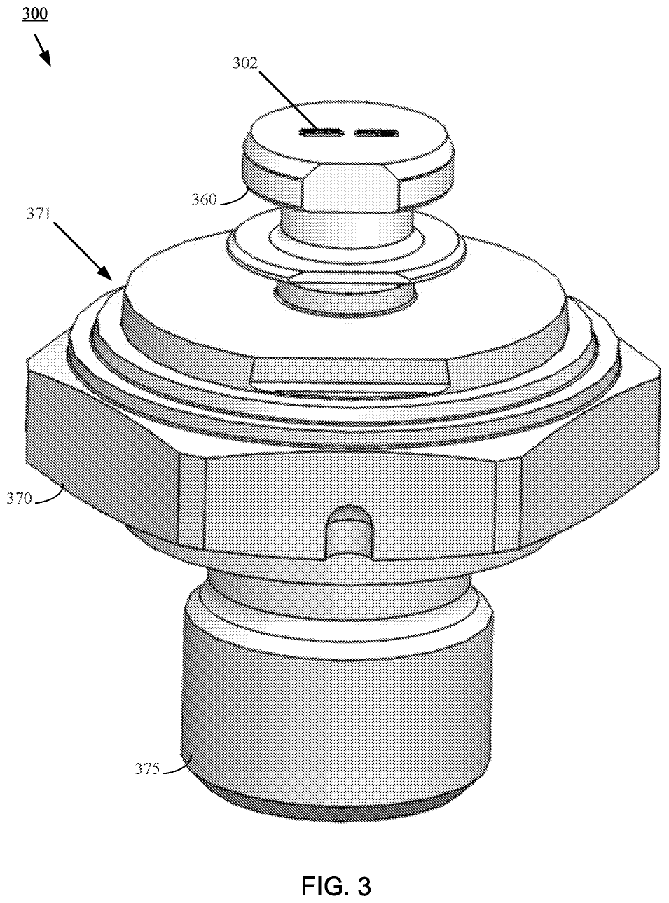

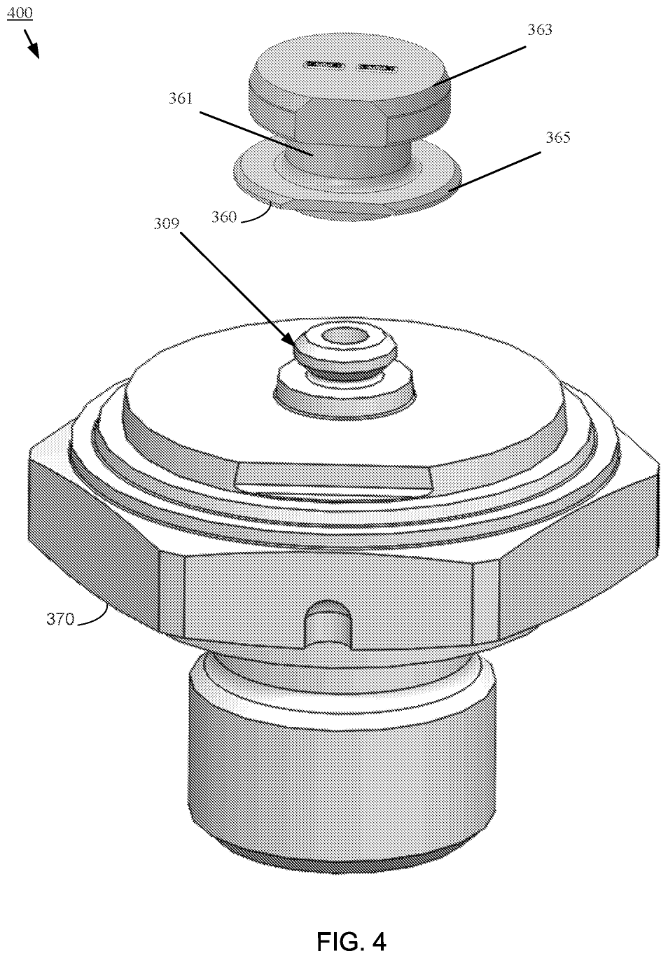

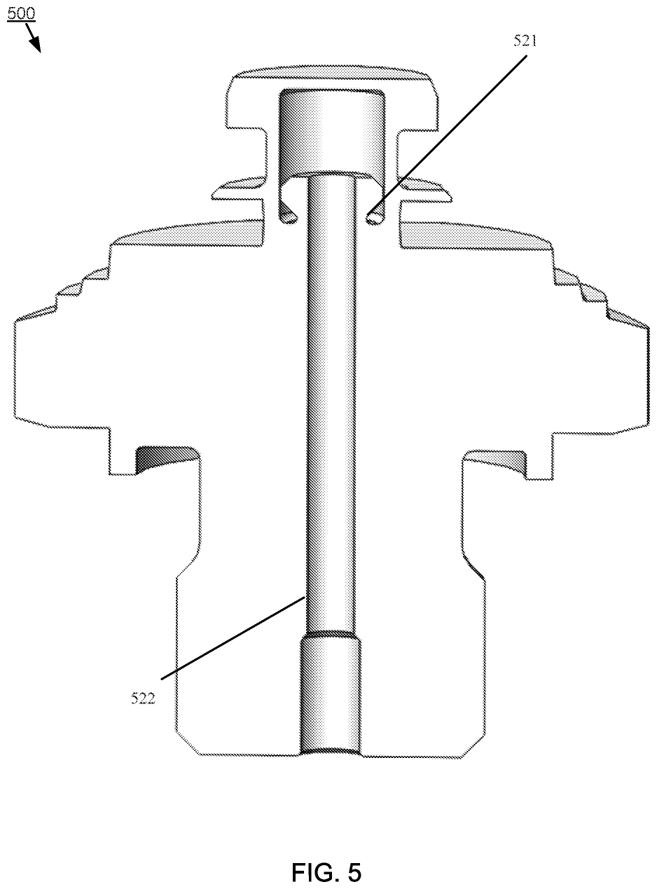

Referring now to FIGS. 3-4, embodiments of the present disclosure propose a low stress concentration split port design for a sensor apparatus 300 which may be assembled together using welding techniques such as laser welding. In some embodiments, sensor apparatus 300 may include a sensing element assembly 302 that may be located on pedestal 360 and port assembly 370 configured to be connected with pedestal 360. Port assembly 370 may include an undercut feature as is shown in FIGS. 5-8 discussed hereinbelow.

In some embodiments, a split port design such as is described herein may be used in various automotive applications (e.g., gasoline direct injection “GDI”). A split port design may be utilized in a GDI due to the sensor sealing requirements.

In some embodiments, pedestal 360 may be and may include sensing element assembly 302 as shown in FIG. 3. Generally, sensing element assembly 302 may include a micro-fused glass portion that may be configured to attach a silicon gauge to the pedestal diaphragm. In operation, when pressure is applied, the pedestal diaphragm may deform. This deformation may transfer to the silicon gauge through the glass portion. The silicon gauge (e.g., one or more piezo-resistors) may endure a resistance change because of strain or deformation.

Referring also to FIG. 4, a circular portion 309 of port assembly 370 may extend through the top of port assembly 370 and may mate with pedestal 360. It should be noted that various features (e.g., circular portion 309), may be of any suitable shape (e.g., when Metal Injection Molding is applied), though sharp edges should be prevented where possible. Additionally and/or alternatively, sensing element assembly 302 does not need to be located in the centerline of the device. Port assembly 370 may include any feature such that it may be fixed tightly to its counter-part in the application and can withstand the application pressure.

Embodiments included herein provide a modular sensor platform that is based on any suitable pressure sensing technology (e.g., micro-strain gauge technology (MSG), thin film, thick film, etc.). The industrial market requires a high mix of product configurations, low volumes and coverage of large range of applications. The combination of high mix and low volume products is challenging to compete with competitors based on cost and price. Large discriminating design and process factors are needed to suppress the manufacturing costs, and lower selling price.

Based on these requirements by the industrial market, embodiments included herein may use a split port weld, wherein port assembly 370 may be welded to sensing element assembly 302 and/or pedestal 360 to minimize the part numbers to suppress cost. The split port weld design included herein may also limit the application pressure of sensor apparatus 300. Embodiments included herein provide for new port assembly geometry, a sensing element pedestal design, and a laser welding methodology that may significantly contribute to the extension of the application pressure range associated with sensing device 300.

In some embodiments, and referring again to FIGS. 3-4, port assembly 370 may be of any suitable shape or design. For example, in some embodiments a hexagonal design may be used for port assembly 370. However, it should be noted that any suitable shape may be used to mount port assembly 370 to an application without departing from the scope of the present disclosure. One or more circular portions may be located on top and/or below port assembly 370. For example, a series of circular portions 371 of varying diameter may be located on top of port assembly 370. Circular base portion of port connector 375 may be located beneath port assembly 370.

In some embodiments, pedestal 360 may include base portion 361 having an inner diameter and a top portion 363 and a bottom portion 365 each having a larger diameter than the base portion 361. At least a portion of circular portion 309 may extend through a top portion of port assembly 370 as shown in FIG. 4.

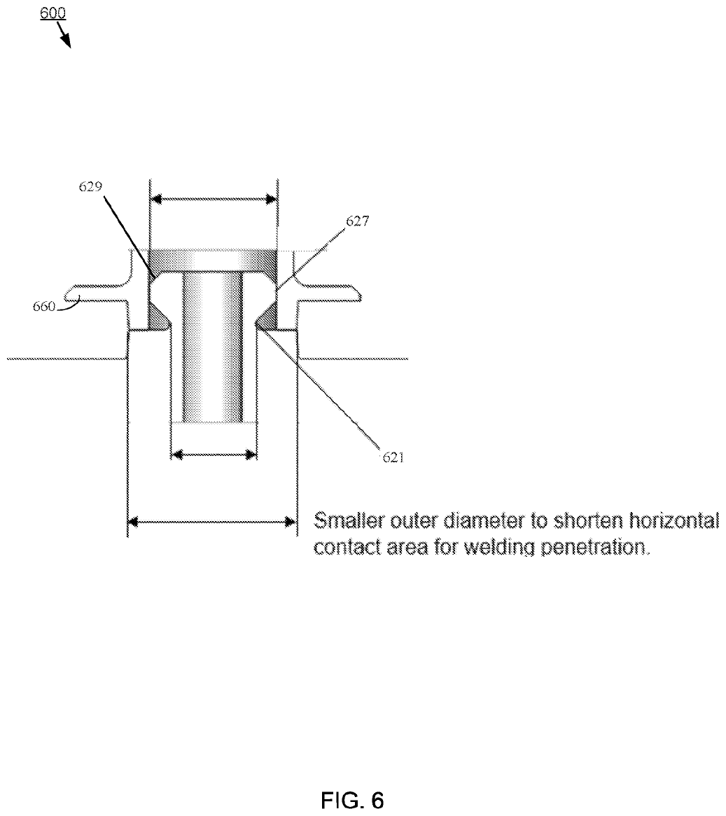

Referring also to FIGS. 5-6, embodiments of sensor devices 500, 600 are provided. These embodiments show an example wherein at least one of port assembly 370 or pedestal 360 may include one or more undercut features 521. Undercut feature 521 may be associated with the top portion of axial passage 522 and may be configured to ensure a fully closed weld between port assembly 370 and pedestal 360. Accordingly, the new welding area may be less sensitive to weld laser power variations compared to the typical split port weld. In this way, embodiments are configured to ensure no features could start tear stresses at the weld interface and relative low stress concentration. As such, undercut feature 521 may reduce and/or eliminate vertical side stress concentration areas. For example, in some embodiments, only smooth radii may remain after welding. The high stresses may be reduced and/or eliminated, only relatively low stress concentrations. Additionally, embodiments provided herein may reduce and/or eliminate any peeling stresses common in existing devices.

Referring also to FIG. 6, an embodiment showing a sensor apparatus 600 having a reduced outer diameter of pedestal 660 in the welding area, with the inner diameter of pedestal unchanged, may cause the weld to penetrate through the entire horizontal contact area of port assembly 406 and pedestal 660. Undercut portion 621 is shown in FIG. 6 and internal guide 627 may be used for pedestal positioning and assembly. An upper chamfered portion 629 may be located above undercut portion 621 and internal guide 627.

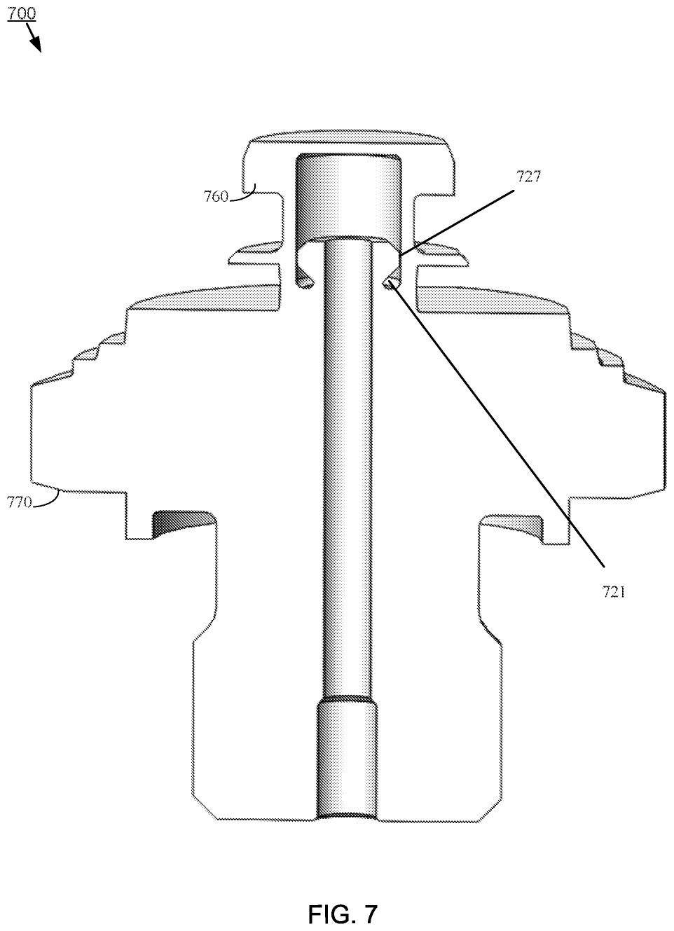

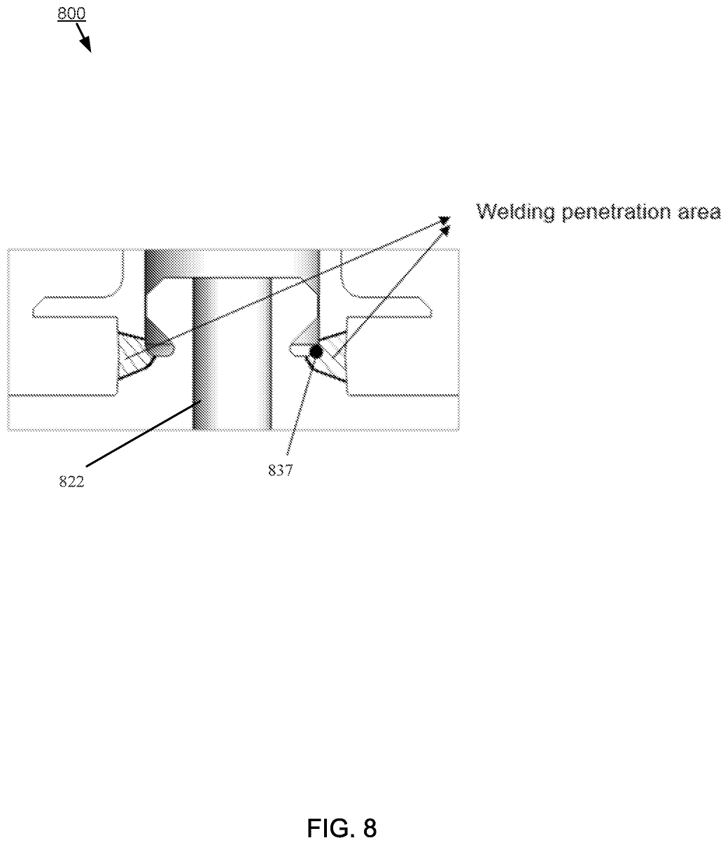

Referring now to FIGS. 7-8, an embodiment showing a sensor apparatus 700 having undercut feature 721 and internal guide 727 is provided. As discussed above, embodiments of the present disclosure may solve issues of prior approaches by using a smaller outer diameter designed for port assembly 770 and pedestal 760. During manufacturing, laser welding may then penetrate through the whole horizontal contact region of port assembly 770 and pedestal 760 so that port assembly 770 is welded to pedestal 760. As shown in FIG. 8, a fillet portion 837 may be generated by welding melt, which may help smooth the transition of the connection of the two parts in order to avoid a concentration of stress.

In some embodiments, some or all of the features described herein may be metallic such as stainless steel. Numerous other materials are also within the scope of the present disclosure.

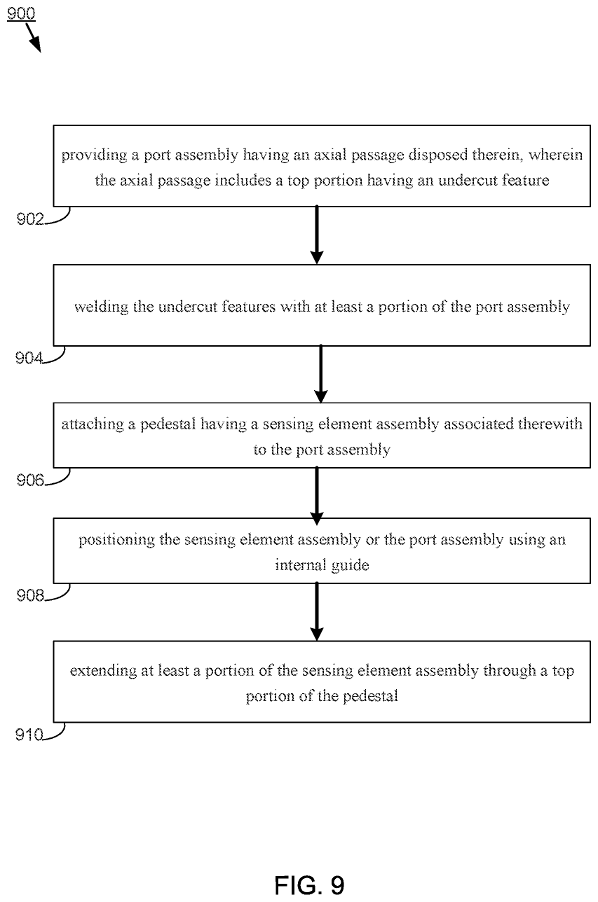

Referring now to FIG. 9, a method of manufacturing a sensing device is provided. Numerous operations may be included without departing from the scope of the present disclosure. Some operations may include providing (902) a port assembly having an axial passage disposed therein, wherein the axial passage includes a top portion having an undercut feature. The method may include welding (904) the undercut feature with at least a portion of the port assembly and attaching (906) a pedestal having a sensing element assembly associated therewith to the port assembly. The method may further include positioning (908) the sensing element assembly or the port assembly using an internal guide and/or extending (910) at least a portion of the sensing element assembly through a top portion of the pedestal. Laser welding parameter settings may be optimized to further minimize stress concentration and/or extend the application pressure ranges.

Embodiments of the present disclosure include a low stress concentration split port design for a port assembly and pedestal which may be assembled together using laser welding. With this new split port design the application pressure range of the sensing device may be extended to a pressure of 600 bar and even higher pressures, which may be beneficial for the sensor's burst pressure level and the sensor's pressure life cycle.

Existing designs may not be used to achieve the necessary pressure range (e.g., 0-600 bar) because the laser welding may not penetrate through the entire horizontal contact region of the port assembly and the sensing element. These existing designs will leave various stress concentration area and cycling high pressure will cause cracks in this region and the crack will extend until leakage happens in the split welding region. Accordingly, embodiments included herein (e.g. and as shown in FIG. 8) may allow for welding penetration through the entire horizontal contact area to eliminate the stress concentration area. In this way, embodiments included herein may minimize stress concentrations and extends the maximum application pressure up to at least 600 bar. The presence of the undercut feature described herein may allow the welding to penetrate through the whole horizontal contact area of port assembly and pedestal. Undercut feature may help to minimize the stress concentration area. Due to this new design, the diameter of the strain gauge may be the same for pressures from 16 bar up to 600 bar, such that no change is required for various manufacturing processes. This is a significant advantage compared to competitive solutions.

Note that techniques herein are well suited for use in any type of sensor application such as pressure sensor assemblies and temperature sensor assemblies as discussed herein. However, it should be noted that embodiments herein are not limited to use in such applications and that the techniques discussed herein are well suited for other applications as well.

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

Having thus described the disclosure of the present application in detail and by reference to embodiments thereof, it will be apparent that modifications and variations are possible without departing from the scope of the disclosure defined in the appended claims.

1. A sensing device, comprising:
a pedestal having a sensing element assembly associated therewith; and
a port assembly configured to mate with the pedestal, wherein the port assembly includes an axial passage having a top portion including an undercut feature positioned to engage with a welded portion.

2. The sensing device of claim 1, wherein the undercut feature includes a rounded portion.

3. The sensing device of claim 1, wherein the sensing element assembly includes a pressure sensor.

4. The sensing device of claim 1, wherein the port assembly is welded to the sensing element assembly.

5. The sensing device of claim 1, wherein the sensing element assembly includes a strain gauge.

6. The sensing device of claim 1, wherein the pedestal has a generally round shape or an elliptical shape.

7. The sensing device of claim 1, wherein the pedestal includes a glass portion located on the top of the pedestal.

8. The sensing device of claim 1, wherein the pedestal includes a base portion having an inner diameter and a top portion and a bottom portion each having a larger diameter than the base portion.

9. The sensing device of claim 1, further comprising:
an internal guide configured to allow for positioning of the sensing element assembly or the port assembly.

10. The sensing device of claim 1, wherein at least a portion of the sensing element assembly extends through a top portion of the port assembly.

11. A method for manufacturing a sensing device, comprising:
providing a port assembly having an axial passage disposed therein, wherein the inner shaft includes a top portion having an undercut feature;
welding the undercut features with at least a portion of the port assembly; and
attaching a pedestal having a sensing element assembly associated therewith to the port assembly.

12. The method of claim 11, wherein the undercut feature includes a rounded portion.

13. The method of claim 11, wherein the sensing element assembly includes a pressure sensor.

14. The method of claim 11, further comprising:
generating a fillet portion resulting from the welding.

15. The method of claim 12, wherein the sensing element assembly includes a strain gauge.

16. The method of claim 15, wherein the pedestal has a generally round shape or an elliptical shape.

17. The method of claim 11, wherein the pedestal includes a glass portion located on the top of the pedestal.

18. The method of claim 11, wherein the pedestal includes a base portion having an inner diameter and a top portion and a bottom portion each having a larger diameter than the base portion.

19. The method of claim 11, further comprising:
positioning the sensing element assembly or the port assembly using an internal guide.

20. The method of claim 11, further comprising:
extending at least a portion of the sensing element assembly through a top portion of the pedestal.
